(19) United States
(12) Patent Application Publication
(10) Pub. No.: US 2011/0180149 A1
(43) Pub. Date: Jul. 28, 2011

(54) SINGLE DIELECTRIC BARRIER DISCHARGE PLASMA ACTUATORS WITH IN-PLASMA catalysts AND METHOD OF FABRICATING THE SAME

(76) Inventors: Neal E. Fine, North Kingstown, RI (US); Steven J. Brickner, Ledyard, CT (US)

(21) Appl. No.: 13/016,141

(22) Filed: Jan. 28, 2011

Related U.S. Application Data
(60) Provisional application No. 61/299,175, filed on Jan. 28, 2010.

(51) Int. Cl. H05H 1/24; B32B 37/02; B32B 37/14; F15D 1/00; B01J 37/02; B01J 37/34; B01J 37/12; B01J 37/04; B01J 37/08

(52) U.S. Cl. 137/1; 315/111.21; 156/60; 502/1

(57) ABSTRACT

A single dielectric barrier plasma actuator is disclosed which includes a pair of offset electrodes and a dielectric barrier therebetween which includes a catalyst at least in the area adjacent one of the electrodes for enhancing the force created in the background gas by the actuator.

This application claims the benefit of U.S. Provisional Application No. 61/299,175 filed Jan. 28, 2010.

### BACKGROUND OF THE INVENTION

1. Field of the Invention

The present invention relates to a catalyst-enhanced single dielectric barrier discharge plasma actuator for use in active control of lift and drag forces generated by wings, airfoils, rotating turbine blades, helicopter blades, bluff bodies, and other lifting and non-lifting bodies operating in an air stream.

2. Description of the Related Art

Single dielectric barrier discharge plasma actuators, also referred to as paraelectric gas flow accelerators and as plasma actuators, have been used to manipulate airflows on a variety of lifting and non-lifting bodies. These actuators, which typically consist of a pair of offset electrodes separated by a dielectric material, generate a force on the neutral background gas that results in a paraelectric gas flow. Applications for such actuators include, for example, active delay of separation near the leading edge of airfoils [1,2], delay of airfoil dynamic stall [3,4], reduction of bluff body drag by delay of separation [5,6], control of separation on turbomachinery blades [7,8], tip drag reduction in turbomachines [9], flow control on wind turbine blades [10], and for other similar applications. [The bracketed numerals used herein refer to the references listed at the end of this specification.]

The single dielectric barrier plasma actuator works as described in the prior art. Plasma is formed when the strong alternating current electric field produces an ionized gas in the region between the two electrodes and above the dielectric layer. The motion of the ions in response to the rapidly changing electric field imparts momentum to the neutral background gas molecules through a series of collisions between the ions and the neutral molecules. The incremental momentum added to the background gas can be used to modify and to improve the aerodynamic forces experienced by an object in an air stream.

While single dielectric barrier discharge plasma actuators have been used with some success, their utility is limited by the small force that is generated by the actuators and applied to the background gas to generate gaseous flow. Maximum forces generated by state-of-the-art actuators are limited to about 0.10 to 0.20 N/m of actuator, while maximum induced velocities are limited to about 3.0 to 6.0 m/s. Enhancement of the force generated by single dielectric barrier discharge plasma actuators beyond these limitations will allow the technology to be applied at a larger range of airspeeds and flow dimensions while lowering the power required for present applications. What is needed in the art is an enhanced single dielectric barrier discharge plasma actuator capable of generating forces in the 0.20 to 0.40 N/m range or higher while inducing gaseous flow rates in the 6.0 to 12.0 m/s range or higher.

### SUMMARY OF THE INVENTION

It has been discovered that the force exerted on the background gas by a single dielectric barrier discharge plasma actuator is enhanced by the addition of a catalyst within the plasma volume. The present invention provides a catalyst-enhanced single dielectric barrier discharge plasma actuator consisting of a pair of offset electrodes separated by a layer of solid dielectric material, the exposed surface of which is coated or impregnated with a thin layer of catalytic material.

The general field of non-thermal atmospheric pressure plasma—including (but not limited to) dielectric barrier discharge plasmas and one-atmosphere uniform glow discharge plasmas—has a great variety of applications including surface sterilization and air purification through oxidation of microorganisms such as bacteria, viruses, molds and other pathogens by reactive species generated by the plasma discharge [11,12], oxidation of volatile organic compounds [13,14], surface treatment to improve wettability [15], and a myriad of others. It has been observed that certain chemical compounds, including (but not limited to) transition metals and rare earth metals lead to enhanced dielectric barrier plasma discharge properties. Specific compounds include photocatalysts (such as rutile and anatase forms of titanium dioxide—TiO₂ and zinc oxide—ZnO), photocatalysts mixed with metals including zinc—Zn, palladium—Pd, platinum—Pt, nickel—Ni, silver—Ag, gold—Au, cerium—Ce, rhodium—Rh, ruthenium—Ru, cadmium—Cd, and others, and other catalysts including aluminum oxide -γ-Al₂O₃ and α-Al₂O₃, manganese oxide—MnO₂, cobalt oxide—CoOₓ, tungsten oxide—WO₃, iron oxide—Fe₂O₃, copper oxide—CuO, and others (including combinations of these). For example, studies have shown that the oxidation of certain volatile organic compounds by the reactive species generated by dielectric barrier discharge plasmas can be significantly enhanced by embedding certain catalysts on the surface of the dielectric barrier that is exposed to the plasma. Depending on the type of catalyst used, this technique has been shown to increase the oxidation efficiency by as much as 300% [16-18].

Research indicates that the rate at which certain reactive species produced in the plasma, including, for example, the superoxide anion O₂⁻, is enhanced through catalytic activity within the plasma and on the surface of the dielectric [16]. When the catalysts are fixed to the surface of—or embedded throughout—the dielectric material in a single dielectric barrier discharge plasma actuator, a greater density of ions is produced in the plasma, leading to a greater number of collisions per unit time between the ions and the neutral background gas. This results in enhanced momentum transfer to the background gas. Hence, single dielectric barrier discharge plasma actuators with a thin coating of catalytic material fixed to the exposed surface of the dielectric, or embedded throughout the dielectric, will lead to enhanced control and improvement of the airflow over lifting and non-lifting bodies.

It is an object of the present invention to provide improved single dielectric barrier discharge plasma actuators.

Another object of the present invention is to provide single dielectric barrier discharge plasma actuators which impact greater momentum to background gas than is produced with known actuators.

Yet another object of the present invention is to provide single dielectric barrier discharge plasma actuators which produce an increase in the force per unit volume imparted to the background gas as compared to prior art actuators.

The above and other objects, features and advantages of the present invention will be apparent to those skilled in the art from the following detailed description of an illustrative embodiment thereof when read in connection with the accompanying drawings wherein:

### BRIEF DESCRIPTION OF THE DRAWINGS

FIG. 1 is an isometric view of a single dielectric barrier discharge plasma actuator constructed in accordance with one embodiment of the invention;

FIG. 1A is a partial plan view of the exposed downstream end of the electrode 100 shown in FIG. 1, on an enlarged scale, to show an embodiment of the invention using serrations on that downstream end;

FIGS. 1B, 1C and 1D show the sinusoidal, negative saw tooth and positive saw tooth voltage wave forms which may be applied to the actuators;

FIG. 2 is an isometric view of an airfoil having plasma actuators according to the invention mounted thereon;

FIG. 3 is an illustration of the experimental setup used to test actuators made according to the invention;

FIGS. 4, 5, 6 and 7 are graphs comparing test results of force measurements for actuators made according to the present invention and an actuator without a catalyst;

FIG. 8 is a chart showing the average force enhancement for the test data at various voltages.

### DETAILED DESCRIPTION OF THE INVENTION

Persons of ordinary skill in the art will realize that the following disclosure is illustrative only and not in any way limiting. Other embodiments of the invention will readily suggest themselves to such skilled persons having the benefit of this disclosure.

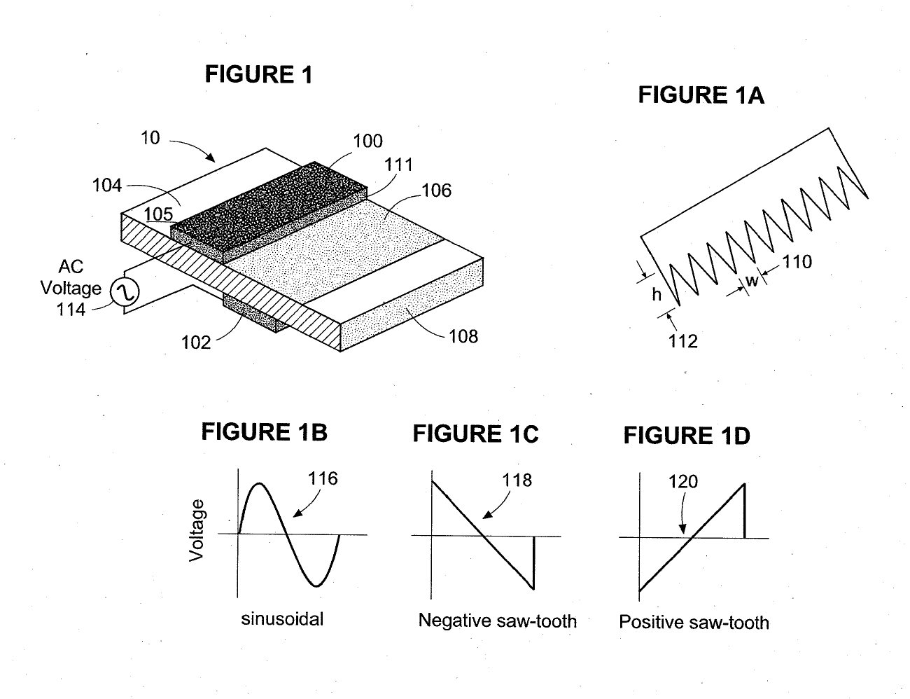

Referring now to the drawings in detail and initially to FIG. 1, a single dielectric barrier discharge plasma actuator 10 according to one embodiment of the invention includes an exposed electrode 100 and a covered electrode 102 which are offset and separated by a layer of dielectric material 104. An alternating current voltage is passed between the electrodes from a source 114 in any known and convenient manner. When the current source is operating and when the voltage exceeds a minimum value, plasma is formed in the area which is adjacent electrode 100 and above electrode 102.

As shown in FIG. 1, in accordance with the present invention, a thin layer of catalyst 106 is fixed to the exposed surface of the dielectric material 104 in the area where the plasma forms. Alternatively, the catalyst can be embedded in the dielectric as shown schematically by the stippled area 108 in FIG. 1. A plasma actuator with a catalyst added to or covering the dielectric will henceforth be referred to as a catalyst-enhanced plasma actuator.

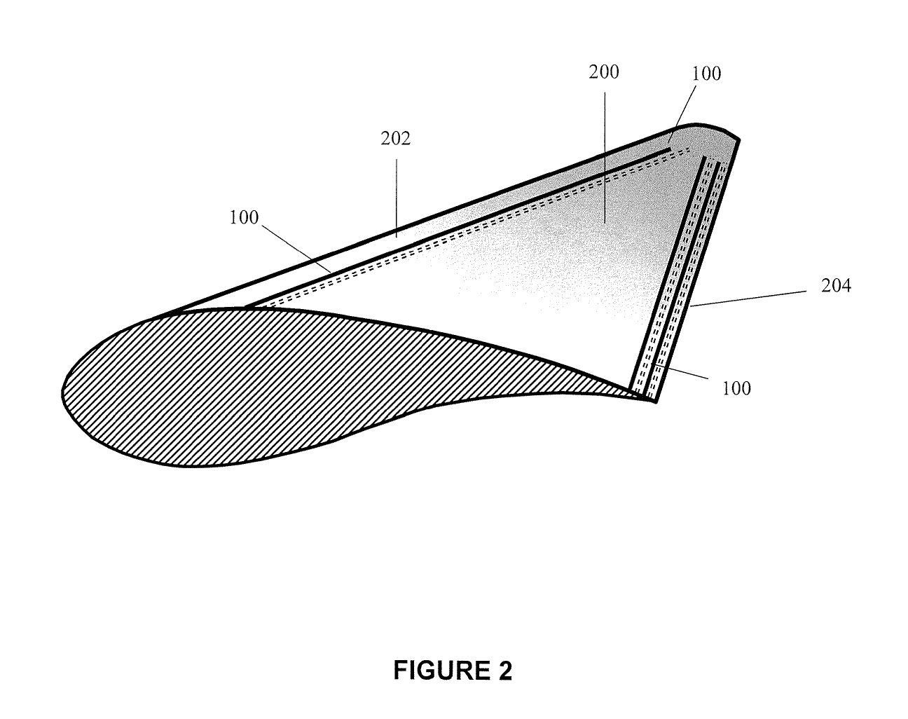

FIG. 2 illustrates a lifting surface 200 (e.g., an aircraft wing) having a plurality of plasma actuators 100 mounted thereon and indicated in the drawing by pairs of parallel dashed lines. In this case, actuators have been placed at the leading edge 202 and the trailing edge 204 of the lifting surface. Upon ignition of the plasma, electrons are ejected from the exposed electrode in the area of the catalyst 106 (See FIG. 1) and interact with neutral molecules in the surrounding air. The interaction produces ions, in numbers approximately equal to the number of free electrons in the plasma. As the ions in the plasma move in response to the changing electric field, they collide with the neutral air molecules in the boundary layer of the airfoil, thus providing a momentum change to the neutral background gas. This momentum change in the boundary layer can be used to prevent separation in the leading edge installation or to control circulation in the trailing edge installation. Multiple actuators can be placed adjacent to one another to provide greater gas flow [19].

A theoretical development of the forces generated by plasma actuators is presented in the literature. Enloe et al. [20] developed an electrostatic model of plasma actuators that relies on the assumption that the time scale on which the force acts on the fluid is much greater than the time scale associated with the motion of electrons and ions in the plasma. In other words, the electrons and ions will very quickly arrange themselves to reach static equilibrium under the influence of the instantaneous electric field. Under this assumption, the governing equations (Maxwell's equations) can be reduced to the Poisson equation for the electrostatic potential, ø:

$${∇}^{2} φ = - \frac{{ρ}_{C}}{{ɛ}_{0}}$$

where ρ_{C} is the charge density and ∈ₒ is the permittivity of free space. Boltzmann's equation relates the local electron and ion density to the electrostatic potential

$${n}_{i , e} = {n}_{0} exp [ \frac{e φ}{{kT}_{i , e}} ]$$

where n₀ is the background plasma density, e is the charge of an electron, k is Boltzmann's constant and T is the ion or electron temperature. Using this equation, the charge density can be written

$$ρ = e ( {n}_{i} - {n}_{e} ) \approx {en}_{0} [ \frac{e φ}{{kT}_{i}} + \frac{e φ}{{kT}_{e}} ] = \frac{{e}^{2} {n}_{0} φ}{k} [ \frac{1}{{T}_{i}} + \frac{1}{{T}_{e}} ] .$$

Making use of the definition of the Debye length, λ_{D} [21]

$${λ}_{D}^{2} = {\frac{{ɛ}_{0} k}{{e}^{2} {n}_{0}} [ \frac{1}{{T}_{i}} + \frac{1}{{T}_{e}} ]}^{- 1}$$

the charge density becomes

$$ρ = - \frac{{ɛ}_{0}}{{λ}_{D}^{2}} φ .$$

The actuator force is a direct result of the fact that there is an electric field in the plasma in regions where there is also a net charge density. The force on the plasma is transferred to the neutral background gas through collisions between the ions and the neutral molecules. The force per unit volume on the plasma can be written

$$\vec{f} = ρ \vec{E} = - \frac{{ɛ}_{0}}{{λ}_{D}^{2}} φ \vec{E} .$$

The force decreases with increasing Debye length. Therefore, greater force would result if one were able to decrease the Debye length.

The basis for the present invention lies in the ability of plasma catalysis to increase the ion/electron density, n₀, and thereby decrease the Debye length, resulting in a net increase in the force per unit volume imparted to the neutral background gas by the actuator. This result has been demonstrated by experiment.

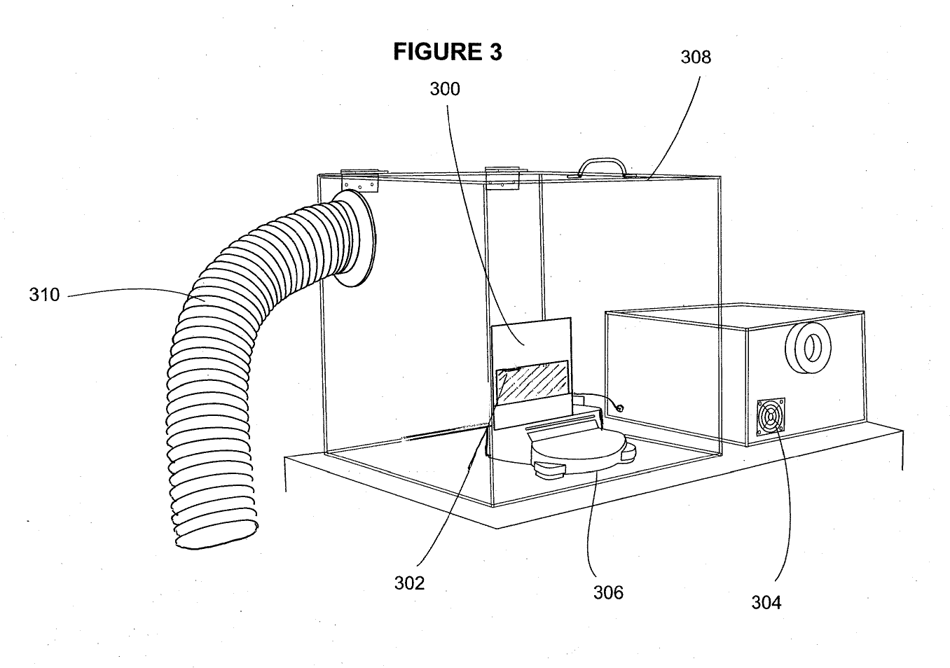

FIG. 3 illustrates the experimental setup. In the experiment, a single dielectric barrier discharge plasma actuator 300 was constructed, first without catalyst and later with a catalyst. A single pair of electrodes was separated by a square 6 in×6 in alumina ceramic plate with a thickness of 0.635 mm. The exposed electrode 302 consisted of a 25.4 mm wide by 127 mm long copper foil tape. The covered electrode (not seen in the drawing) was 50.8 mm wide by 127 mm long copper foil tape. Two layers of 3M Scotch 130C dielectric tape were used to cover the back side of the alumina ceramic plate. The electrodes were connected to a power supply 304 which provided up to 16 kV rms of electrical potential across the electrodes. The power supply consisted of a Titan MAC-02 mainframe amplifier with a Titan MOS-01 oscillator coupled to a pair of Crowne 25× step-up transformers. The a/c frequency was set to 5 kHz. The actuator was placed on an OHAUS A812 precision scale 306 capable of measuring forces up to 812 g with a precision of 0.01 g. The actuator and scale were housed in a Plexiglas box 308 to protect the measurement from extraneous airflow and to protect the user from any ozone produced by the plasma. A duct 310 with a small fan (not shown) was connected to the Plexiglas box to siphon off the gases. A manganese oxide honeycomb catalyst was placed over the duct entrance to partially remove the ozone.

The weight of the actuator and holding apparatus was recorded with the voltage off. The weight was then measured and recorded for rms voltages of 4.0 kV, 4.5 kV, 5.0 kV, 5.5 kV and 6 kV. At higher voltages, the plasma “saturated” and no additional force was generated. The voltage was then returned to zero and the static weight was again measured and recorded. The measurements were then repeated for a total of four trials in order to estimate the variability in the results.

The actuator 300 was then removed from the scale and the dielectric was coated with a thin layer of liquid consisting of 5000-8000 ppm nano-particle sized TiO₂ (anatase form) and 25-50 ppm Zn in water. The mixture was purchased from Ecoactive Surfaces, Inc, located at 551-0 NE 27^{th} Street, Pompano Beach, Fla. The liquid mixture was sprayed on with a single pass of an air brush powered by compressed air and set to a low volumetric flow rate. Following application, the dielectric was dried for one hour by placing the ceramic roughly 3 inches in front of a 500 W halogen bulb. After drying, the actuator and holding apparatus were returned to the scale and the force was again measured for rms voltages of 4.0 kV, 4.5 kV, 5.0 kV, 5.5 kV and 6 kV. As before, the measurements were repeated four times in order to estimate variability in the results.

The procedure described above was repeated 5 times, each time with a new actuator. For the fifth actuator, however, a false catalyst (tap water) was used in place of the titanium dioxide/zinc mixture. This was done to rule out the possibility that the measurement procedure was introducing a variation caused by something other than the catalyst.

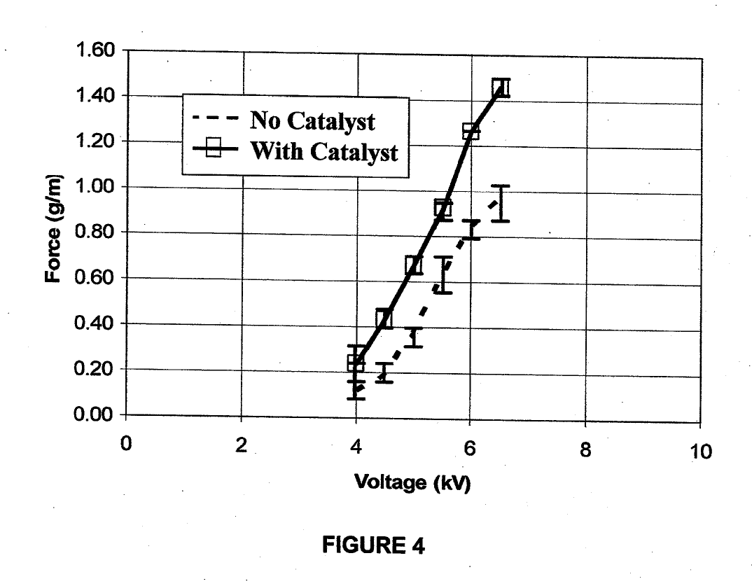

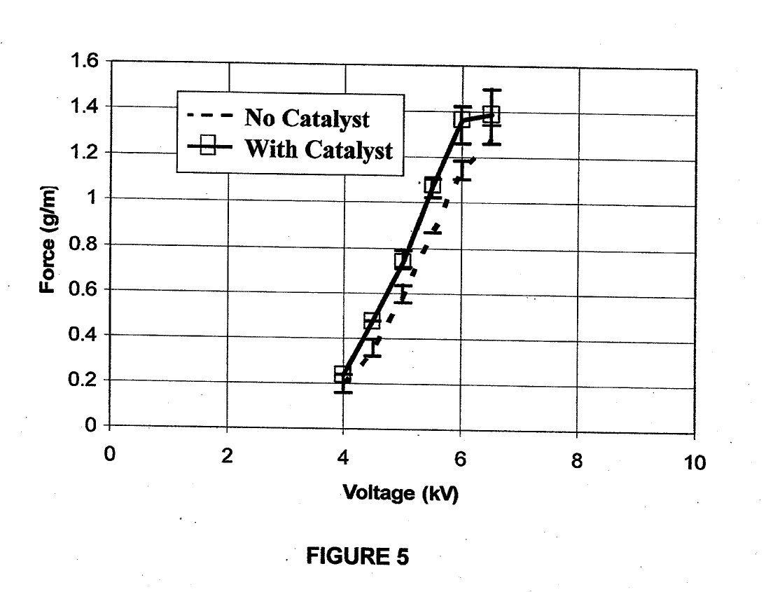

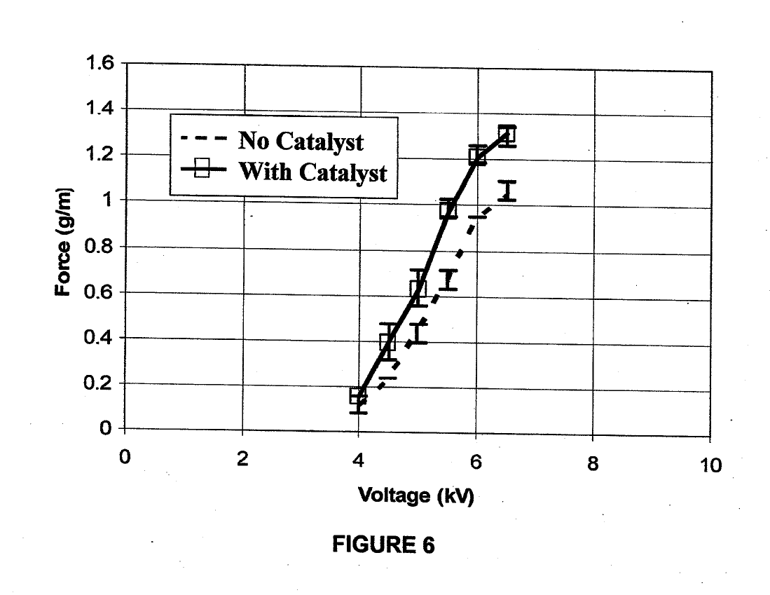

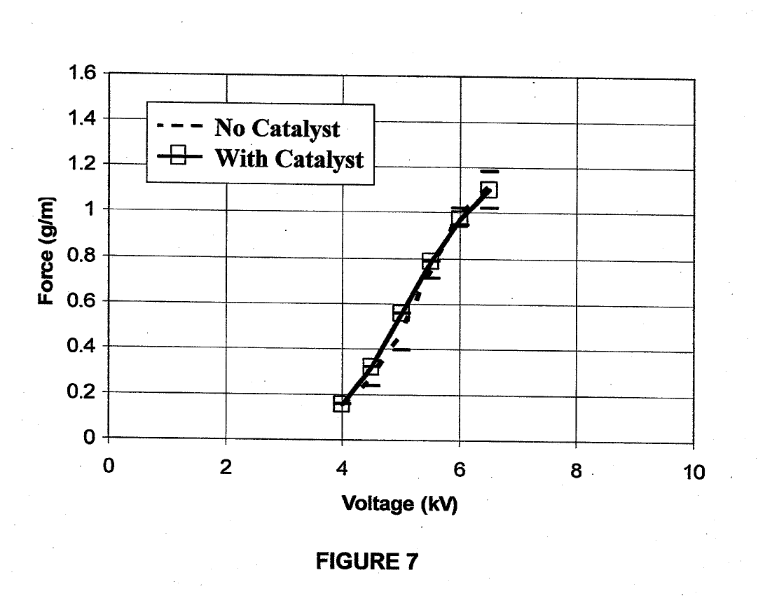

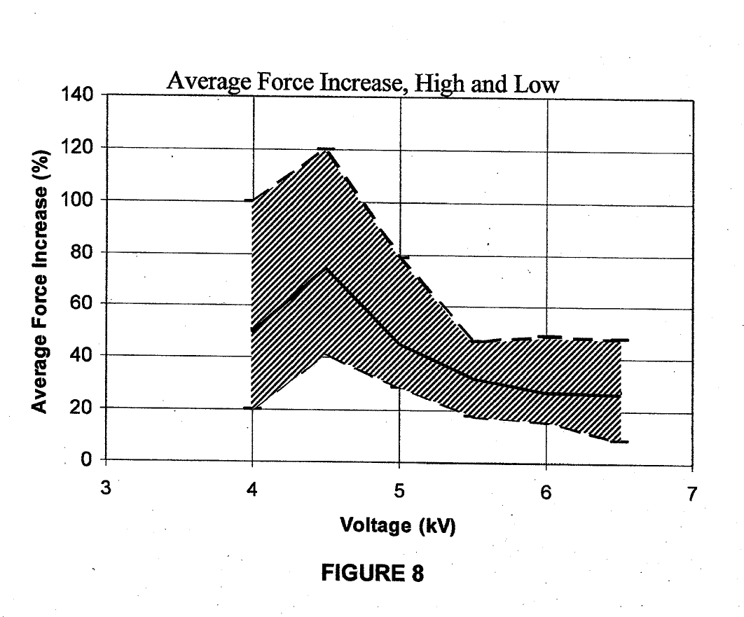

The results of these experiments are presented in FIGS. 4-8. These results clearly indicate that a consistent, repeatable and significant increase in actuator force is obtained through use of the titanium dioxide/zinc catalyst.

The experiment described above was not designed to show optimum actuator performance; higher forces will result from optimizing the physical parameters of the actuator design, including the dielectric material, the dielectric thickness, the voltage waveform, rms voltage, frequency and other geometric and physical parameters. This experiment was designed to demonstrate an increase in force resulting from a catalyst-enhanced plasma actuator.

In the embodiment of the invention as illustrated in FIG. 1 the actuator consists of a pair of electrodes, preferably consisting of one-sided copper tape with conductive adhesive, one electrode being exposed to the background gas and one covered by dielectric material 104, as shown in FIG. 1. The exposed electrode 100 is about 6 mm to about 50 mm (25.4 mm preferred) in width, about 0.04 mm to about 0.20 mm in thickness (0.04 mm preferred), and with an arbitrary span that depends on the application. The dimensions of the covered electrode 102 are about 6 mm to about 75 mm (50.8 mm preferred) in width, with thickness similar to the exposed electrode, and with the same span as the exposed electrode.

The upstream edge 105 of the exposed electrode should be covered with thin dielectric material, such as Kapton polymide film tape (0.04 mm to 0.5 mm in thickness, with 0.05 mm preferred), to prevent formation of plasma along that edge. Similarly, any side-edges of the exposed electrode should be covered with the same thin dielectric material. The downstream edge 111 of the exposed electrode 100 may be straight as shown in FIG. 1 or it may have serrations. The serrations embodiment is shown in the enlargement of FIG. 1A and can have a height 112 of about 10% to about 90% of the exposed electrode width (50% preferred). The serrations can have width 110 of about 10% to about 100% of the height 112 (25% preferred).

The two electrodes 100, 102 are separated by the layer of dielectric material 102. The thickness of the dielectric material is about 0.25 mm to about 9.0 mm (6.35 mm preferred). The dielectric constant of the material is about 2.0 to about 8.0 (about 3.0-4.0 preferred). A first class of dielectric materials that may be used include materials such as fused quartz, Teflon®, Delrin®, Alumina ceramic, glass-mica ceramic, mica wafers, Kapton®, Kevlar®, and others. A second class of dielectric materials includes a broad array of commercially available polymer clays that include polymer polyvinyl chloride monomers and various plasticizers; and, ceramic and glass-ceramic matrix materials. The second class of dielectric material is preferred for the ease of shape-forming and for the ability to form a matrix with various doping agents or catalysts.

In some applications, it may be desirable to add a second dielectric barrier above the exposed electrode. This configuration is generally referred to as a double dielectric barrier discharge plasma actuator.

The voltage waveform from source 114 can be sinusoidal 116, a positive saw-tooth 118 or a negative saw-tooth 120 (positive saw-tooth preferred). These are shown in FIGS. 1B, 1C and 1D respectively. The rms voltage amplitude is about 1 kV to about 30 kV, with about 20 kV preferred. The duty cycle can be about 100% (continuous) to about 10% (pulsed), with the latter preferred (but dependent on the particular requirements of the application). The a/c frequency is about 1 kHz to about 20 kHz, with about 2-6 kHz preferred.

A catalyst is fixed to the surface area 106—or embedded within the matrix 108—of the dielectric 102. The applicable catalysts may consist of (but are not limited to) photocatalysts (such as rutile and anatase forms of titanium dioxide—TiO₂, and zinc oxide—ZnO), photocatalysts mixed with metals including zinc—Zn, palladium—Pd, platinum—Pt, nickel—Ni, silver—Ag, gold—Au, cerium—Ce, rhodium—Rh, ruthenium—Ru, cadmium—Cd, and others, and other catalysts including aluminum oxide -γ-Al₂O₃ and α-Al₂O₃, manganese oxide—MnO₂, cobalt oxide—CoOₓ, tungsten oxide—WO₃, iron oxide—Fe₂O₃, copper oxide—CuO, and others (including combinations of these). In some cases, these metals and compounds will be commercially available as titanium-dioxide-supported metal catalysts, such as Zn/TiO₂. In other cases, they can be prepared by methods derived from the literature [22,23].

For the case where the catalyst is fixed to the surface of the dielectric, the procedure for fixing the material may include first preparing the surface of the dielectric through exposure to atmospheric plasma, followed by spraying the catalyst-water mixtures in a thin coating, followed by drying at a temperature of 50-400 degrees Celsius (100-200 degrees preferred) for a period of 0.05 to 12.0 hours (1.0 hours preferred). The drying can be done in an oven (e.g., calcination) or by exposing the catalyst-wetted dielectric to a high wattage infrared or incandescent lamp. For the case where the catalyst is pre-mixed with the dielectric material, the catalyst may either be mixed into the matrix or applied to the surface of the soft dielectric prior to baking and hardening.

It will be evident to those skilled in the art that other formulations that are not aqueous based, such as ethanol or other organic solvents may be used to spray a suspension of the catalyst mixtures. Further, alternate methods of applying catalyst mixtures to the surface of the actuator involve first applying an adhesive followed by application of a dry powder consisting of catalyst compounds. In addition, certain pigmented polyimide films or para-aramid synthetic fiber (Kevlar®), where the pigments include compounds, such as titanium dioxide, can be applied to the surface of the dielectric.

As is known to one skilled in the art of photocatalysis, there are several preparation methods for formation of titanium dioxide thin films, including spray coating, spin coating, chemical vapor deposition, sol-gel and electro-deposition methods [24].

An alternate method for the deposition of a supported TiO₂/γ-Al₂O₃ catalyst includes a method involving plasma mediated oxidation of TiCl₄ adsorbed onto the Al₂O₃ dielectric, as described by Zhang et. al [25].

TiO₂/SiO₂ and TiO₂/Al₂O₃ preparation by sol-gel methods has been described, and have been shown to have improved activity relative to TiO₂ alone in the photocatalytic decomposition of phenol [26].

Kim et. al [26] reported that the photocatalytic activity of TiO₂ was improved by chemical solution deposition of other metal oxides, including Fe₂O₃ and Al₂O₃, on the surface of the TiO₂ particles (as applied to destruction of organic materials in waste solvents). These preparations had improved activity versus commercially available P-25 TiO₂. References therein describe methods for chemical vapor deposition, metal-organic chemical vapor deposition and sol-gel approaches to preparing metal oxide modification of TiO₂.

References cited in brackets above are listed below and submitted in a separate Information Disclosure statement:
1. Post, M. L., and Corke, T. C., “Separation Control on a High Angle of Attack Airfoil Using Plasma Actuators,” AIAA Journal, Vol. 42, No. 11, 2004, pp. 2177-2184.
2. Benard, N., Braud, P., and Jolibois, J., “Airflow Reattachment Along a NACA 0015 Airfoil by Surface SDBD Actuator-Time Resolved PIV Investigation,” AIAA Paper 2008-4202, 2008.
3. Post, M. L., and Corke, T. C., “Separation Control Using Plasma Actuators-Dynamic Stall Vortex Control on an Oscillating Airfoil,” AIAA Journal, Vol. 44, No. 12, 2006, pp. 3125-3135.
4. Roth, J. R. “Optimization of the Aerodynamic Plasma Actuator as an EHD Electrical Device,” 44^{th} AIAA Aerospace Sciences Meeting, January 2006.
5. Do, H., Kim, W., Mungal, M. O., and Cappelli, M. A., “Bluff Body Flow Separation Control Using Surface Dielectric Barrier Discharges,” AIAA Paper 2007-939, 2007.
6. Thomas, F. O., Kozlov, A., and Corke, T. C., “Plasma Actuators for Cylinder Flow Control and Noise Reduction,” AIAA Journal, Vol. 46, No. 8, 2008, pp. 1921-1931.
7. Huang, J., Corke, T. C., and Thomas, F. O., “Plasma Actuators for Separation Control of Low-Pressure Turbine Blades,” AIAA Journal, Vol. 44, No. 1, 2006, pp. 51-57.
8. Huang, J., Corke, T. C., and Thomas, F. O., “Unsteady Plasma Actuators for Separation Control of Low-Pressure Turbine Blades,” AIAA Journal, Vol. 44, No. 7, 2006, pp. 1477-1487.
9. Van Ness, D. K., II, Corke, T. C., and Morris, S. C., “Turbine Tip Clearance Flow Control Using Plasma Actuators,” AIAA Paper 2006-0021, 2006.
10. Nelson, R. C., T. C. Corke, H. Othman, M. P. Patel, S. Vasudevan and T. Ng, “A Smart Wind Turbine Blade Using Distributed Plasma Actuators for Improved Performance,” AIAA paper 2008-1312, 2008.
11. Kelly-Wintenberg, K. (2004), “Atmospheric Plasma Decontamination,” Final Report, Technical Services Working Group, Contract N41756-04-C-4155.
12. Kelly-Wintenberg, K. (2006), “Eradicating biofilm with an atmospheric glow plasma,” Final Report, NIH Phase II SBIR, Contract 2 R44DE0139892-02A1. Period of Performance: Mar. 1, 2003-Nov. 30, 2005.
13. Coogan, J. J. and A. S. Jassal, “Silent Discharge Plasma (SDP) for Point-of-Use (POU) Abatement of Volatile Organic Compound (VOC) Emissions: Final Report (ESHC003),” Technology Transfer #97023244A-ENG, SEMATECH, February 1997.
14. Sobacchi, M. G., A. V. Saveliev, A. A. Friedman, A. Gutsol and L. A. Kennedy, “Experimental Assessment of Non-Thermal Plasma Techniques for Removal of Paper Industry VOC Emissions,” 15^{th} International Symposium on Plasma Chemistry, Orleans, July 9-13, 2001. Symposium Proceedings, Vol. VII: Poster Contributions, pp. 3135-3140.
15. Roth, J. R., “Potential Industrial Applications of the One Atmosphere Uniform Glow Discharge Plasma (OAUGDP®) Operating in Ambient Air,” Physics of Plasmas, Vol. 12, No. 5 Part 2 (2005) paper 057103.
16. Van Durme, J., J. Dewulf, C. Leys and H. V. Langenhove, “Combining Non-Thermal Plasma with Heterogeneous Catalysis in Waste Gas Treatment: A Review,” Applied Catalysis B: Environmental 78 (2008), pp 324-333.
17. Ayrault, C. J. Barrault, J-M Tatibouet, S. Pasquiers and P. Tardiveau, “VOC Removal by a Plasma-Catalytic Process,” American Physical Society 57^{th} Gaseous Electronics Conference, Shannon, The Republic of Ireland, September 2004.
18. Chevadey, S., W. Kiatubolpaiboon, P. Rangsunvigit, T. Sreethawong, “A Combined MultiStage Corona Discharge and Catalytic System for Gaseous Benzene Removal: Journal of Molecular Catalysis A: Chemistry, Vol 263, No. 1, 2007, pp 128-136.
19. Thomas, F. O., T. C. Corke, M. Iqbal, A. Kozlov and D. Schatzman, “Optimization of Dielectric Barrier Discharge Plasma Actuators for Active Aerodynamic Flow Control,” AIAA Journal, Vol. 47, No. 9, September 2009, pp 2169-2178.
20. Enloe, L., McLaughlin, T., VanDyken, Kachner, Jumper, E., and Corke, T. Mechanisms and responses of a single-dielectric barrier plasma actuator: Plasma morphology. AIAA 42 (2004), 589-594.
21. Roth, J. R., Industrial Plasma Engineering, Volume 1, Institute of Physics Publishing, Ltd, 1995.
22. Rampaul, A., I. P. Parkin, S. A. O'Neill, J. DeSouza, A. Mills, and N. Elliot, “Titania and Tungsten doped titania thin films on glass; active photocatalysts,” Polyhedron, Vol 22 35-44, 2003.
23. Kim, H. A., A. Ogata, S. Futamura, “Oxygen partial pressure-dependent behavior of various catalysts for the total oxidation of VOCs using cycled-system of adsorption oxygen plasma,” Applied Catalysis B: Environmental, Vol. 79, pp 356-367, 2008.
24. Ishikawa, Y. and Matsumoto, Y., “Electrodeposition of TiO₂ photocatalyst into nano-pores of hard alumite,” Electrochim. Acta. 46: 2819-2824, 2001.
25. Zhang, X.-L., L.-H. Nie, Y. Xu, C. Shi, X.-F. Yang, A.-M. Zhu, “Plasma oxidation for achieving supported TiO₂ photocatalysts derived from adsorbed TiCl₄ using dielectric bather discharge,” J. Phys. D: Appl. Phys., Vol. 40, pp 1763-1768, 2007.
26. Anderson, C. and A. J. Bard, “Improved Photocatalytic Activity and Characterization of Mixed TiO₂/SiO₂ and TiO₂/Al₂O₃ Materials,” J. Phys. Chem. B, Vol. 101 No. 14, pp 2611-2616, 1997.
27. Kim, T. K., M. N. Lee, S. H. Lee, Y. C. Park, C. K. Jung, and J.-H. Boo, “Development of surface coating technology of TiO₂ powder and improvement of photocatalytic activity by surface modification,” Thin Solid Films, Vol. 475, pp 171-177, 2005.

Although the invention has been described herein with reference to the specific embodiments shown in the drawings it is to be understood that the invention is not limited to such embodiments and that various changes and modifications may be affected therein without departing from the scope or sphere of the invention. In addition, the claims set forth below and their content form a part of this disclosure and specification.

We claim:

1. A catalyst-enhanced single dielectric barrier discharge plasma actuator apparatus comprising:
a) a pair of electrodes;
b) a dielectric barrier separating said electrodes;
c) said dielectric barrier including a catalytic material that acts as a plasma catalyst exposed to the plasma; and
d) a high voltage power supply providing high amplitude alternating current electric potential across the electrodes.

2. The apparatus as defined in claim 1, wherein the catalytic material is a photocatalyst.

3. The apparatus as defined in claim 2, wherein the photocatalyst is combined with metal or metal oxide particles.

4. The apparatus as defined in claim 1, wherein the catalytic material is comprised of metal or metal oxide particles.

5. The apparatus as defined in claim 1, wherein the catalyst is fixed to the surface of the dielectric separating the electrode pair.

6. The apparatus as defined in claim 1, wherein the dielectric material separating the electrode pair is a matrix embedded with catalyst.

7. The apparatus as defined in claim 1, wherein the dielectric material has a dielectric constant of about 2.0 to about 8.0.

8. The apparatus as defined in claim 1, wherein the power supply delivers alternating current electrical potential with RMS voltage between 1 kV and 30 kV at frequencies between 1 kHz and 20 kHz.

9. The apparatus as defined in claim 2, wherein the photocatalyst is selected from a group consisting of titanium dioxide, zinc oxide and similar photocatalysts and the preferred photocatalyst is titanium dioxide.

10. The apparatus as defined in claim 3 or 4, wherein the metal or metal oxide is selected from a group consisting of zinc, palladium, platinum, nickel, silver, gold, cerium, rhodium, ruthenium, and cadmium, or their respective oxides where appropriate, tungsten oxide and iron oxide.

11. The apparatus as defined in claim 3, wherein one photocatalyst is combined with up to three metals or metal oxides selected from the group consisting of zinc, palladium, platinum, nickel, silver, gold, cerium, rhodium, ruthenium, and cadmium.

12. The apparatus as defined in claim 1, wherein the pair of electrodes is offset and/or overlapping.

13. The apparatus as defined in claim 1, wherein the plasma is a one atmosphere uniform glow discharge plasma.

14. The apparatus as defined in claim 1, wherein the single dielectric barrier is replaced with a double dielectric barrier.

15. A method of generating a force on a gas, comprising the step of causing a gaseous flow using a catalyst-enhanced single dielectric barrier discharge plasma actuator.

16. The method of claim 15, including the step of using two or more catalyst-enhanced single dielectric barrier discharge plasma actuators are placed adjacent to one another.

17. The method of claim 15, wherein the step of causing a gaseous flow includes preventing separation at or near the leading edge on the suction side of airfoils, wings and rotating lifting surfaces.

18. The method of claim 15, wherein the step of causing a gaseous flow includes controlling the circulation and resulting lift and drag forces of airfoils, wings and rotating lifting surfaces.

19. The method of claim 15, wherein the step of causing a gaseous flow includes reducing flow separation on the suction side of airfoils, wings and rotating lifting surfaces.

20. The method of claim 15, wherein the step of causing a gaseous flow includes controlling the flow on the surface of wind turbine blades.

21. The method of claim 15, wherein the step of causing a gaseous flow includes controlling flow separation on bluff bodies to reduce drag.

22. The method of claim 15, wherein the step of causing a gaseous flow includes increasing flow acceleration and reducing flow separation in the inlet of turbomachinery.

23. The method of claim 15, wherein the step of causing a gaseous flow includes reducing unsteady loads on rotating lifting surfaces and reducing associated radiated noise.

24. A method for preparing a catalyst-enhanced single dielectric barrier discharge plasma actuator comprising the step of providing a dielectric barrier material in the actuator with a plasma catalyst material.

25. The method of claim 24, including the step of first exposing the surface of the dielectric material to atmospheric plasma followed by spraying a mixture containing a plasma catalyst on the dielectric barrier.

26. The method of claim 25, including the step of exposing the surface of the dielectric material to a lamp emitting visible or infrared light following application of the mixture containing the catalyst.

27. The method of claim 24, wherein the catalyst to be applied is contained in an aqueous mixture or a mixture with ethanol or any other suitable organic solvent.

28. The method of claim 24, wherein the step of providing the dielectric barrier with a plasma catalyst is selected from the group consisting of spray coating, spin coating, chemical vapor deposition, plasma deposition, sol-gel and electro-deposition methods.

29. The method of claim 24, wherein the catalyst is titanium dioxide and the dielectric is alumina and the step of providing the dielectric barrier with a plasma catalyst includes plasma mediated oxidation of TiCl₄ adsorbed onto the Al₂O₃ dielectric.

30. The method of claim 24, wherein the plasma catalyst is embedded in the dielectric matrix by thoroughly mixing with the polymer clay or ceramic prior to forming the actuator and baking to a desired hardness.

31. The method of claim 24, wherein the catalyst is embedded in the outer layer of the dielectric matrix by application of said catalyst by injection into the polymer clay or ceramic prior to forming the actuator and baking to a desired hardness.

32. A single dielectric barrier plasma actuator comprising offset electrodes and a dielectric barrier therebetween including a photocatalyst.

33. An actuator as defined in claim 32, wherein the dielectric barrier is coated with the catalyst on one side adjacent one of the electrodes.

34. An actuator as defined in claim 33, wherein the dielectric barrier is coated in photocatalyst.

35. An actuator as defined in claim 33, wherein the dielectric barrier is coated in photocatalyst with a metal or metal oxide suspension.

36. An actuator as defined in claim 32, wherein the dielectric is embedded with catalyst.

37. An actuator as defined in claim 36, wherein the dielectric is embedded with photocatalyst with a metal or metal oxide suspension.

38. An actuator as defined in any one of claims 32-37, supplied to the leading edge of an airfoil for separation control.

39. An actuator as defined in any one of claims 32-37, applied to the trailing edge of an airfoil for circulation control.

40. An actuator as defined in any one of claims 32-37, applied anywhere along the chord of an airfoil for flow manipulation.

41. An actuator as defined in any one of claims 32-27, for use on wind turbine blades.

42. An actuator as defined in any one of claims 32-37, applied to bluff bodies for control of separation and reduction of drag.

43. An actuator as defined in any one of claims 32-37, applied to turbomachinery inlets for increased flow acceleration and reduced separation.

44. An actuator as defined in any one of claims 32-37, applied to noise reduction due to uneven loading in unsteady air flows.

45. An enhanced single dielectric barrier plasma actuator comprising a dielectric barrier, a first exposed electrode on one side of the barrier, and a second electrode on the opposite side of the barrier offset from the first electrode wherein said barrier layer includes a catalyst at least adjacent said first exposed electrode and over said second electrode.

46. An enhanced plasma actuator as defined in claim 45 wherein said catalyst is in the form of a layer of photocatalyst.

47. An enhanced plasma actuator as defined in claim 45, wherein said catalyst is embedded in said dielectric barrier.

48. The method of making an enhanced single dielectric barrier plasma actuator comprising the steps of:
a) providing a dielectric barrier layer;
b) applying a first exposed electrode on one side of the barrier layer;
c) applying a second electrode on the other side of the barrier layer offset from the first electrode; and
d) providing said barrier layer with a catalyst material at least in the area thereof adjacent said first exposed electrode and over said second electrode.

49. The method as defined in claim 48, wherein the step of providing the barrier layer with a catalyst material comprises the step of coating at least said area with the catalyst.

50. The method as defined in claim 48, wherein the step of providing the barrier layer with a catalyst material comprises the step of embedding said catalyst within at least said area.

51. The actuator as defined in claim 32, wherein said catalyst is selected from the group consisting of titanium dioxide, palladium, platinum, nickel, zinc oxide, aluminum oxide, manganese oxide, cobalt oxide and tungsten oxide.

51. The method as defined in claim 48, wherein said catalyst is selected from the group consisting of titanium dioxide, palladium, platinum, nickel, zinc oxide, aluminum oxide, manganese oxide, cobalt oxide and tungsten oxide.
